(19) United States
(12) Patent Application Publication
(10) Pub. No.: US 2007/0216949 A1
(43) Pub. Date: Sep. 20, 2007

(54) System and method for processing graphic data in a printer device

(75) Inventor: Fu-Chang Lin, Taipei (TW)

Correspondence Address: BRUCE H. TROXELL, SUITE 1404, 5205 LEESBURG PIKE, FALLS CHURCH, VA, 22041, US

(73) Assignee: Destiny Technology Corporation

(21) Appl. No.: 11/377,305

(22) Filed: Mar. 17, 2006

(51) Int. Cl. G06F 3/12

(52) U.S. Cl. 358/1.18; 358/1.15

(57) ABSTRACT

A system and method for processing graphic data in a printer device. A full frame is divided into a plurality of to-be-printed sub-images and a valid region is determined from each of the to-be-printed sub-images and marked. The information about the valid region and an area of the full frame is transmitted for each valid region. Sequentially, the graphic data in the valid region are determined to define a plurality of to-be-processed graphic data units when each graphic data unit is to be printed. Then, the to-be-processed graphic data units are printed. As such, speed of the printing task with respect to the graphic data may be promoted.

### FIELD OF THE INVENTION

The present invention relates to a system and method for processing graphic data, and more particularly to a system and method for processing graphic data in a printer device.

### BACKGROUND OF THE INVENTION

Referring to FIG. 1, a schematic diagram illustrating a conventional valid data block transmission method by an operating system to a printer device is shown therein. A printer device such as a printer receives the graphic data of a full frame 2 having a to-be-printed image 4 and then prints the full frame 2. In the printing process, the graphic data of the full frame 2 is processed by pre-dividing the full frame into blocks 6.

As shown, in the full frame 2, only the portion at the left side of a thick line 1a-1c is to be printed and the full frame 2 is divided into blocks 1 to 7. In the prior art, the blocks 1 to 5 are deemed as a valid region 10 while the block 6 is deemed as an invalid region 12.

The above mentioned graphic data is composed of a plurality of graphic data units and transmitted by an operating system such as Microsoft Windows when required to be printed. Further, the curve data required by the operating system is transformed into a plurality of points measured in the coordinate so that the point data may be determined as to they are valid or invalid data.

Next, all the graphic data transmitted by the operating system are determined once as to which block 6 each of the graphic data are located in by comparing the coordinate thereof. If the graphic data is determined as within blocks 1 to 5, the corresponding graphic data is involved in the real printing operation. Otherwise, the graphic data are discarded without being printed.

Now the process is described with respect to an example. A coordinate of each of the graphic data unit 1a to 1c is acquired. First, the graphic data unit 1a is determined as located within the block 1 and then allowed to be printed. Then, the same process is performed on an adjacent graphic data unit and then to the other graphic data units until the determination process with respect to the graphic data unit 1c is finished. Such determination process involves a huge data processing amount and thus causes the processing time lengthened.

In contrast to the coordinate-based determination manner, the graphic data unit may be determined by being previously presented as its constituent line segments.

For example, the curve 1a-1b is divided into n line segments. Now assuming that the graphic data unit 1a has a coordinate value of (200,100) and the graphic data unit 1b has a coordinate value (100,50). Then, the line segments are segment 1: (100,50)→(102,51), segment 2:(100,51)→(103,52), segment 3:(101,52)→(104,53), . . . , segment n:(199,99)→(200,100), which amounts to a huge data amount. When such graphic data form is adopted in the determination process with respect to the block 6, the printing efficiency is further worsen.

Therefore, there is a need to provide a system and method for processing graphic data in a printer device so as to solve the above described problem and a problem of inconsistency printing with respect to a long side and a short side of the full frame.

### SUMMARY OF THE INVENTION

It is, therefore, an object of the present invention to provide a system and method for processing graphic data for a printing device so as to enhance efficiency and speed of a printing process.

In the system and method for processing graphic data in a printer device according to the present invention, the graphic data corresponds to a full frame intended to be printed by the printer device, comprises a piece of to-be-printed image data, which corresponds to a to-be-printed image in the full frame printed by the printing device and is composed of a plurality of graphic data units.

The to-be-printed image is pre-divided into a plurality of to-be-printed sub-images each having a plurality of to-be-printed sub-image data and located within a rectangular region comprising a plurality of valid sub-regions amounting to a valid region.

The system in a printer device for processing graphic data comprises a data transmission module, a mark module, a data read module, a determination module and a print module.

The data transmission module is embedded in an operating system (OS) and used for transmitting data corresponding to the valid region in the graphic data corresponding to the full frame. Sequentially, the mark module is used to mark the valid data corresponding to the valid region. The data read module is used to acquire each graphic data unit of the graphic data corresponding to the full frame in order.

The determination module is used to compare each of the graphic data units and a corresponding piece of the marked valid data so that the graphic data units in the valid region may be determined and are defined as a plurality of processed graphic data units. The print module is used to print out the to-be-processed graphic data units.

Accordingly, by implementation of the system and method for processing graphic data in a printer device of the present invention, the to-be-processed graphic data units may be rapidly determined and printed since the valid data in the valid regions have been marked beforehand and only the graphic data in the valid regions are printed out without the need to compare blocks one by one as used in the prior art. As such, the to-be-printed images in the full frame may be printed out in a rapid and efficient manner.

Other objects, advantages and efficacies of the present invention may be better understood after the detailed description below is read in connection to the accompanying drawings

### BRIEF DESCRIPTION OF THE DRAWINGS

FIG. 1 is a schematic diagram illustrating a conventional valid data block transmission by an operating system (OS) to a printer device;

FIG. 2 is a schematic diagram of a full frame according to the present invention;

FIG. 3 is a schematic diagram of a system in a printer device for processing graphic data according to the present invention; and

FIG. 4 is a flowchart illustrating a method of processing graphic data in the printer device according to the present invention.

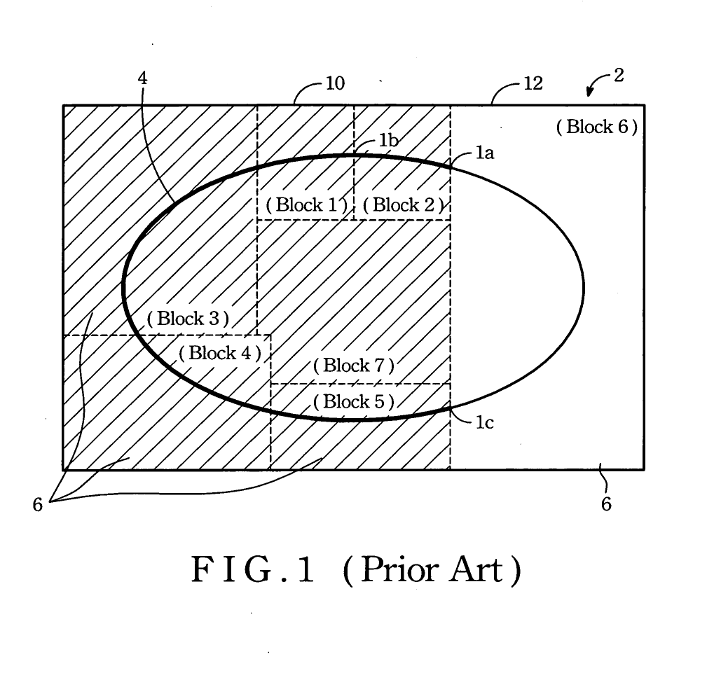

### DETAILED DESCRIPTION OF THE PREFERRED EMBODIMENT

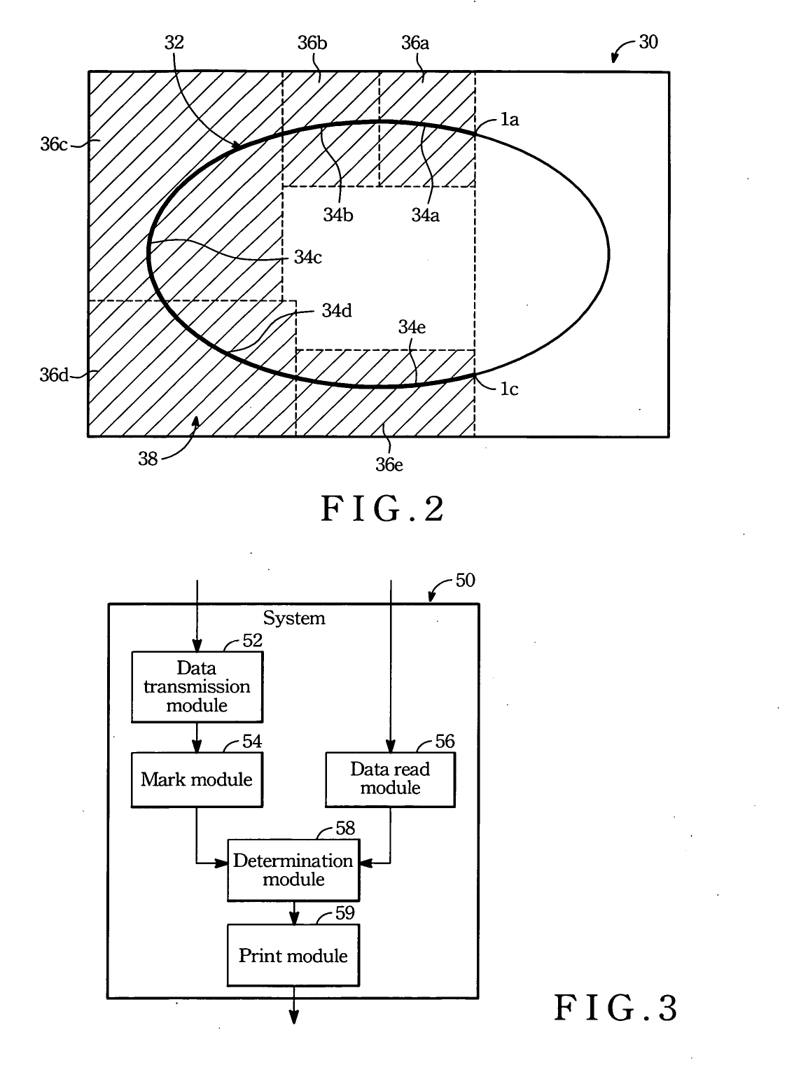

Referring to FIG. 2, a schematic diagram of a full frame according to the present invention is shown therein. A system in a printer device for processing graphic data is disclosed in the present invention, through which the full frame 30 is printed by the printer device. The graphic data comprises a plurality of piece of to-be-printed image data, each of which corresponding to a to-be-printed image 32 in the full frame 30 intended to be printed by the printer device, which is a thick curve 1a-1c at the left side of an ellipse in FIG. 2. The graphic data is composed of a plurality of graphic data units.

The to-be-printed images 32 corresponding to the printed image data are divided into a plurality of to-be-printed sub-images 34a-34e each having a piece of to-be-printed sub-image data. In FIG. 2, the to-be-printed images 32 of a curve ranged from 1a to 1b are divided into a plurality of to-be-printed sub-images 34a-34e in order.

A rectangular region in which the to-be-printed sub-images 34a-34e is a plurality of valid sub-regions 36a-36e. In FIG. 2 the rectangular region corresponding to the to-be-printed sub-images 34a-34e is the valid sub-regions 36a-36e, which amounts to a valid region 38.

Referring to FIG. 3, the system-in a printer device for processing graphic data is schematically shown therein. The system 50 comprises a data transmission module 52, a mark module 54, a data read module 56, a determination module 58 and a print module 59.

The data transmission module 52 is embedded in an operating system (OS), such as Microsoft Windows, and used for transmitting data corresponding to a valid region 38 in the graphic data corresponding to the full frame. The marking module 54 is used to mark a piece of valid data corresponding to the valid region 38. The data read module 56 is used to acquire each of graphic data unit among the graphic data units of the graphic data corresponding to the full frame in order.

The determination module 58 is used to compare each of the graphic data units and a corresponding one of the marked -valid data so that the graphic data units in the valid region 38 may be determined and defined as a plurality of to-be-processed graphic data units. The print module 59 is used to print out the graphic data units after the plurality of to-be-process graphic data units are defined.

Incidentally, the relationships among the full frame 30, valid sub-regions 36a-36e and valid regions 38 are determined by measuring them in the same coordinate.

To pursue a better efficiency, the data read module 56 may only acquire the images located within an ellipse in the full frame 30 without the need to acquire each of the graphic data units one by one. Then, the curve is transformed into a plurality of horizontal lines, vertical lines and oblique lines by subjecting the curve to a dividing and partitioning process.

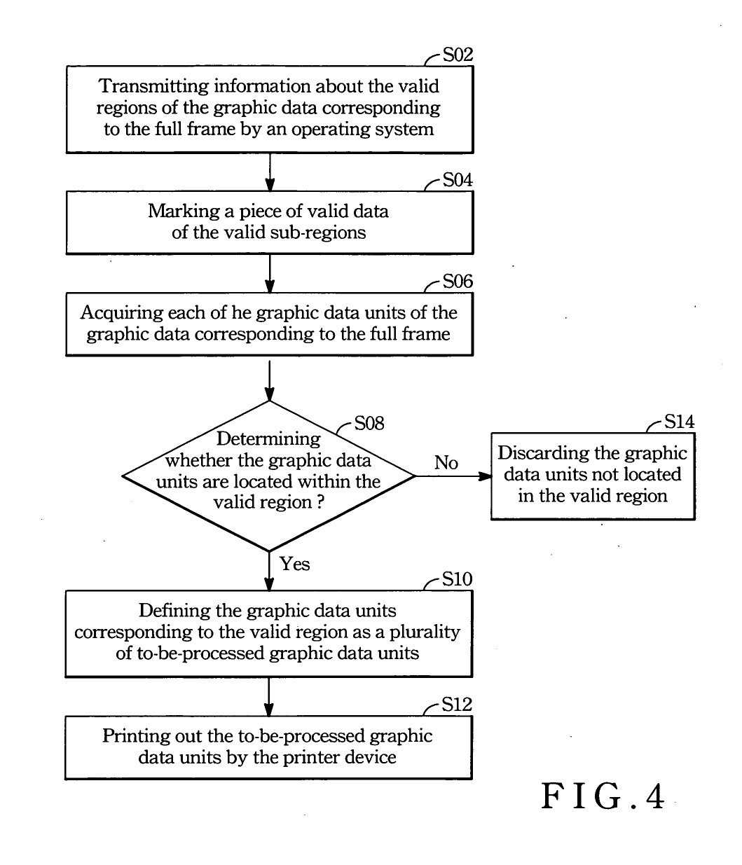

Referring to FIG. 4, a flowchart of the method for processing graphic data in a printer device according to the present invention is shown therein. The method may be performed on the aforementioned system. Likewise, the graphic data refers to those corresponding to the full frame 30 to be printed by the printer device and the graphic data is composed of a plurality of graphic data units.

The to-be-printed images 32 in the full frame 30 corresponding to the to-be-printed image data is divided into a plurality of to-be-printed sub-images 34a-34e each having a piece of to-be-process sub-image data. In FIG. 2, a curve 1a-1b is the to-be-printed image 32 which is divided into to-be-printed sub-images 34a-34e.

A rectangular region in which the to-be-printed sub-images 34a-34e is located is a plurality of valid sub-regions 36a-36e. In FIG. 2, the rectangular region corresponding to the to-be-printed sub-images 34a-34e is the valid sub-regions 36a-36e, which amounts to a valid region 38.

The method for processing graphic data in a printer device comprises the following steps.

Step S02: information about a maximum area and the valid regions of the full frame 30 is transmitted by the OS such as Microsoft Windows and a corresponding area in a memory is arranged for storage of the rectangular area in which the valid region 38 is located 38 in the full frame 30 as shown in FIG. 2.

Step S04: the valid data of the valid-sub-regions 36a-36e are marked so that the valid region 38 may be clearly recognized.

Step S06, the graphic data in the full frame 30 are transformed into a plurality of single horizontal lines or points as graphic data units, each of which is successively acquired in order.

Step S08: the graphic data units and the marked valid data are compared to determine whether the graphic data units are located within the valid region 38.

If yes in Step S08, the process goes into S10: the graphic data units in the valid region 38 are defined as a plurality of to-be-processed graphic data units.

Step S12: the to-be-processed graphic data units are printed out by the printer device.

If no in Step S08, the process enters Step S14: the graphic data units not located in the valid region 38 are discarded.

Accordingly, with utilization of the system 50 and method for processing graphic data in a printer device of the present invention, the to-be-processed graphic data units may be rapidly determined and printed since the valid data in the valid region 38 have been marked beforehand and only the graphic data in the valid region 38 are printed out without the need to compare blocks one by one as used in the prior art. As such, the to-be-printed images 32 in the full frame 30 may be printed in a rapid and efficient manner.

From reading the present disclosure, other modifications will be apparent to persons skilled in the art. Such modifications may involve other features which are already known to arrangements for selecting the largest of a number of input signals and to Data decoders including such arrangements and parts thereof and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation of one or more of those features which would be obvious to persons skilled in the art, whether or not it relates to the same invention as presently claimed and whether or not it mitigates any or all of the same technical problems as does the present invention. The applicants hereby give notice that new claims may be formulated to such features and/or combinations of such features during the prosecution of the present application or of any further application derived therefrom.

What is claim is:

1. A method for processing graphic data in a printer device, the graphic data corresponding to a full frame to be printed by the printer device and comprising a piece of to-be-printed image data corresponding to a to-be-printed image in the full frame to be printed by the printer device, the to-be-printed image is pre-divided into a plurality of to-be-printed sub-images each having a piece of to-be-printed sub-image data and located within a rectangular region comprising a plurality of valid sub-regions amounting to a valid region, the method comprising the following steps:
transmitting information about the valid regions of the graphic data corresponding to the full frame by an operating system (OS);
marking a piece of valid data of the valid sub-regions;
acquiring each of he graphic data units of the graphic data corresponding to the full frame to determine whether the graphic data units are located within the valid region and defining the graphic data units corresponding to the valid region as a plurality of to-be-processed graphic data units; and
printing out the to-be-processed graphic data units by the printer device.

2. The method according to claim 1, wherein relationships among the full frame, the valid sub-regions and valid regions are determined by using a coordinate system.

3. A system in a printer device for processing graphic data, the graphic data corresponding to a full frame to be printed by the printer device and comprising a piece of to-be-printed image data corresponding to a to-be-printed image in the full frame to be printed by the printer device, the to-be-printed image is pre-divided into a plurality of to-be-printed sub-images each having a piece of to-be-printed sub-image data and located within a rectangular region comprising a plurality of valid sub-regions amounting to a valid region, the system comprising:
a data transmission module embedded in an operating system (OS) and used for transmitting data corresponding to the valid region in the graphic data corresponding of the full frame;
a marking module used to mark the valid data corresponding to the valid region;
a data read module used to acquire each graphic data unit in the graphic data unit of the graphic data of the full frame in order;
a determination module used to compare each of the graphic data units and a corresponding one of the valid data marks so that the graphic data units in the valid region may be determined and are defined as a plurality of processed graphic data units; and
a print module used to print out the graphic data units.

4. The system according to claim 3, wherein relationships among the full frame, the valid sub-regions and valid regions are determined by using a coordinate system.
